(19) United States
(12) Patent Application Publication
(10) Pub. No.: US 2025/0111613 A1
(43) Pub. Date: Apr. 3, 2025

(54) INFORMATION PROCESSING APPARATUS, DATA GENERATION METHOD, AND NON-TRANSITORY COMPUTER-READABLE MEDIUM

(71) Applicant: NEC Corporation, Tokyo (JP)

(72) Inventors: Shigeo SUZUKI, Tokyo (JP); Akira TSUJI, Tokyo (JP); Takanori SHIGETA, Tokyo (JP); Yusuke KUNII, Tokyo (JP)

(73) Assignee: NEC Corporation, Tokyo (JP)

(21) Appl. No.: 18/898,060

(22) Filed: Sep. 26, 2024

(30) Foreign Application Priority Data
Oct. 2, 2023 (JP) 2023-171386

(51) Int. Cl. G06T 19/00; G06T 7/00

(52) U.S. Cl. CPC G06T 19/00; G06T 7/0002; G06T 2207/10028; G06T 2207/30232; G06T 2210/56; G06T 2219/004

(57) ABSTRACT

An object of the present disclosure is to provide an information processing apparatus capable of displaying information useful for performing monitoring work. An information processing apparatus according to the present disclosure includes: a generation unit configured to generate three-dimensional data including a monitoring target facility; a data acquisition unit configured to acquire sensor data detected by at least one sensor configured to monitor the monitoring target facility; and a display control unit configured to generate display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

### INCORPORATION BY REFERENCE

This application is based upon and claims the benefit of priority from Japanese patent application No. 2023-171386, filed on Oct. 2, 2023, the disclosure of which is incorporated herein in its entirety by reference.

### TECHNICAL FIELD

The present disclosure relates to an information processing apparatus, a monitoring system, a data generation method, and a program.

### BACKGROUND ART

When inspecting equipment installed in a substation, the equipment may be inspected by using an image taken by using a sensor such as light detection and ranging (LiDAR). A person who inspects the equipment checks a three-dimensional shape of each piece of the equipment and determines normality of the equipment.

Patent Literature 1 discloses an inspection support system that enables an inspector to inspect equipment in an inspection site at a monitoring place remote from the inspection site. The inspection support system includes a sensor disposed at the inspection site and an unmanned moving body including a microphone that collects ambient sound. The inspector remotely monitors the inspection site by visually recognizing an image on which information collected by using the sensor and the unmanned moving body is displayed.
Patent Literature 1: Japanese Unexamined Patent Application Publication No. 2020-149349

### SUMMARY

The inspection support system disclosed in Patent Literature 1 displays, on a device, a three-dimensional image of inspection target equipment, a sound source of sound collected by the unmanned moving body, a type of odor, and the like. Herein, when remotely monitoring equipment installed in a substation or the like, it is required that more useful information is displayed on a display device or the like in order for a monitoring person to efficiently execute monitoring work.

In view of the above-described problem, an example object of the present disclosure is to provide an information processing apparatus, a monitoring system, a data generation method, and a program that make it possible to display information useful for performing monitoring work.

In a first example aspect according to the present disclosure, an information processing apparatus includes: a generation unit configured to generate three-dimensional data including a monitoring target facility; a data acquisition unit configured to acquire sensor data detected by at least one sensor that monitors the monitoring target facility; and a display control unit configured to generate display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

In a second example aspect according to the present disclosure, a monitoring system includes: at least one sensor configured to monitor a monitoring target facility; a generation apparatus configured to generate three-dimensional data including the monitoring target facility; an information processing apparatus including a data acquisition unit configured to acquire sensor data detected by at least one of the sensors, and a display control unit configured to generate display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility; and a display apparatus configured to display the display data.

In a third example aspect according to the present disclosure, a data generation method includes: generating three-dimensional data including a monitoring target facility; acquiring sensor data detected by at least one sensor that monitors the monitoring target facility; and generating display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

In a fourth example aspect according to the present disclosure, a program causes a computer to execute: generating three-dimensional data including a monitoring target facility; acquiring sensor data detected by at least one sensor that monitors the monitoring target facility; and generating display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

### BRIEF DESCRIPTION OF DRAWINGS

The above and other aspects, features, and advantages of the present disclosure will become more apparent from the following description of certain example embodiments when taken in conjunction with the accompanying drawings, in which:

FIG. 1 is a configuration diagram of an information processing apparatus according to the present disclosure;

FIG. 2 is a diagram illustrating a flow of data generation processing according to the present disclosure;

FIG. 3 is a configuration diagram of the information processing apparatus according to the present disclosure;

FIG. 4 is a diagram illustrating three-dimensional data according to the present disclosure;

FIG. 5 is a diagram illustrating three-dimensional data according to the present disclosure;

FIG. 6 is a diagram illustrating three-dimensional data according to the present disclosure;

FIG. 7 is a diagram illustrating a flow of data display processing according to the present disclosure;

FIG. 8 is a configuration diagram of the information processing apparatus according to the present disclosure;

FIG. 9 is a configuration diagram of a monitoring system according to the present disclosure;

FIG. 10 is a diagram illustrating a flow of additional data generation processing according to the present disclosure;

FIG. 11 is a configuration diagram of the monitoring system according to the present disclosure; and

FIG. 12 is a configuration diagram of the information processing apparatus according to the present disclosure.

### EXAMPLE EMBODIMENT

### First Example Embodiment

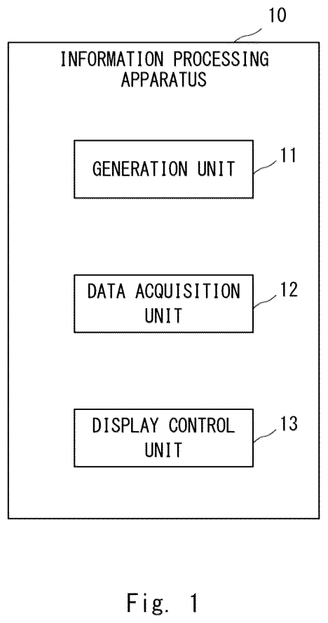

Hereinafter, a configuration example of an information processing apparatus 10 will be described with reference to FIG. 1. The information processing apparatus 10 may be a computer apparatus that operates when a processor executes a program stored in a memory.

The information processing apparatus 10 includes a generation unit 11, a data acquisition unit 12, and a display control unit 13. The generation unit 11, the data acquisition unit 12, and the display control unit 13 may be software or modules that execute processing when a processor executes a program stored in a memory. Alternatively, the generation unit 11, the data acquisition unit 12, and the display control unit 13 may be hardware such as a circuit or a chip.

The generation unit 11 generates three-dimensional data including a monitoring target facility. The monitoring target facility may be a facility that needs to be monitored periodically or at any timing. The monitoring target facility may be, for example, a building, a road, an apparatus, a component, or the like. Specifically, the monitoring target facility may be equipment arranged in a substation, a power plant, or the like.

The three-dimensional data may be, for example, data indicating a three-dimensional position of the monitoring target facility in a predetermined three-dimensional space. The three-dimensional data may be generated based on data measured using a sensor or the like. Further, the three-dimensional data may be generated using software that generates three-dimensional data from two-dimensional data such as a drawing. The three-dimensional data may be, for example, point cloud data. Further, the three-dimensional data may be mesh data, polygon data, or the like generated using point cloud data. Further, the three-dimensional data may be data represented by using a depth map.

The data acquisition unit 12 acquires sensor data detected by at least one sensor that monitors the monitoring target facility. The at least one sensor may be built in the information processing apparatus 10. Further, the at least one sensor may be externally attached to the information processing apparatus 10. Further, the at least one sensor may be installed at a position different from the information processing apparatus 10 and may communicate with the information processing apparatus 10 via a network.

The sensor for monitoring the monitoring target facility may be a camera, a light detection and ranging (LiDAR) apparatus, a temperature sensor, a humidity sensor, a vibration sensor, an acceleration sensor, a microphone, an odor sensor, a global positioning system (GPS) sensor, or the like. The temperature sensor may be, for example, thermography. However, the sensor for monitoring the monitoring target facility is not limited thereto, and an apparatus for detecting various data may be used.

The camera and the LiDAR apparatus generate, for example, sensor data which make it possible to determine whether an abnormality occurs visually. The temperature sensor, the humidity sensor, the vibration sensor, and the acceleration sensor generate sensor data which make it possible to determine whether an abnormality occurs tactilely. The microphone generates sensor data which make it possible to determine whether an abnormality occurs aurally. The odor sensor generates sensor data which make it possible to determine whether an abnormality occurs olfactorily. The GPS sensor may be used as an apparatus for generating auxiliary data for determining whether an abnormality occurs.

The display control unit 13 generates display data that displays, on three-dimensional data, abnormality data acquired by combining a plurality of types of sensor data. The abnormality data are data indicating an abnormal state that occurs in the monitoring target facility. Alternatively, the display control unit 13 generates display data of displaying, on the three-dimensional data, abnormality data acquired by combining at least one piece of sensor data and information related to the monitoring target facility.

Displaying the abnormality data on the three-dimensional data may be combining the abnormality data with the three-dimensional data. Alternatively, displaying the abnormality data on the three-dimensional data may be displaying the abnormality data and the three-dimensional data at the same time.

The plurality of types of sensor data may be sensor data generated in two or more sensors that generate different types of data. For example, the type of data may be sensor data that make it possible to determine whether an abnormality occurs visually, tactilely, aurally, or olfactorily.

The information related to the monitoring target facility may be, for example, the position of the monitoring target facility, the size of the monitoring target facility, the weight of the monitoring target facility, a material constituting the monitoring target facility, a function of the monitoring target facility, a substance flowing inside the monitoring target facility, a service provided or used by the monitoring target facility, and the like.

The monitoring person of the monitoring target facility can determine whether an abnormality occurs in the monitoring target apparatus by checking the display data displayed on a display apparatus or the like.

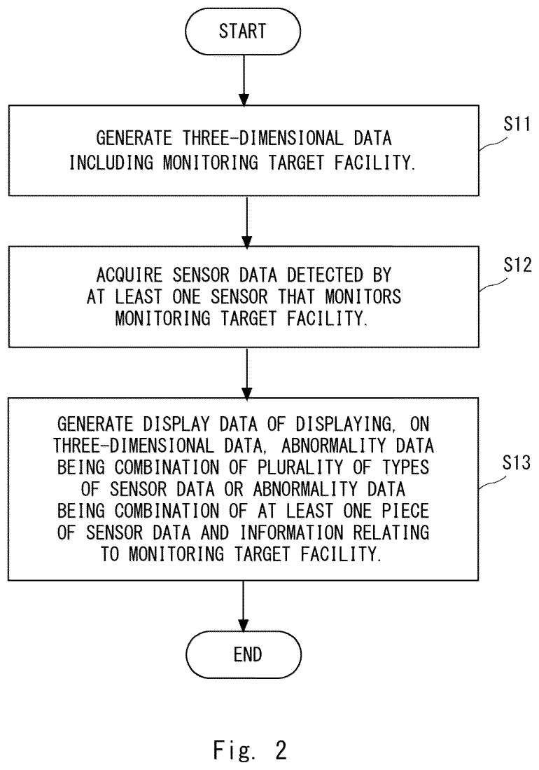

Next, a flow of processing of a data generation method executed in the information processing apparatus will be described with reference to FIG. 2. First, the generation unit 11 generates three-dimensional data including a monitoring target facility (S11). Next, the data acquisition unit 12 acquires sensor data detected by at least one sensor that monitors the monitoring target facility (S12). Then, the display control unit 13 generates display data of displaying, on the three-dimensional data, abnormality data indicating an abnormal state that occurs in the monitoring target facility, which is acquired by combining a plurality of types of sensor data (S13). Alternatively, the display control unit 13 generates display data of displaying, on the three-dimensional data, abnormality data indicating an abnormal state that occurs in the monitoring target facility, which is acquired by combining at least one piece of sensor data and information related to the monitoring target facility (S13).

As described above, the information processing apparatus 10 generates abnormality data indicating an abnormal state that occurs in the monitoring target facility acquired by combining a plurality of types of sensor data or by combining at least one piece of sensor data and information related to the monitoring target facility. Further, the information processing apparatus 10 generates display data of displaying the abnormality data on the three-dimensional data.

The abnormality data includes a combination of a plurality of types of sensor data, therefore indicates useful information that cannot be acquired from information indicated by a single type of sensor data. Further, the abnormality data includes a combination of at least one piece of sensor data and information related to the monitoring target facility, therefore indicates useful information that cannot be acquired from information indicated by a single type of sensor data. The useful information may be, for example, a cause of occurrence of an abnormality, a severity of an abnormality, or the like. The monitoring person monitors the display data acquired by combining the three-dimensional data indicating the monitoring target facility and the abnormality data, thereby efficiently performs determination of the cause of occurrence of the abnormality, determination of a treatment at the time of the occurrence of the abnormality, and the like.

### Second Example Embodiment

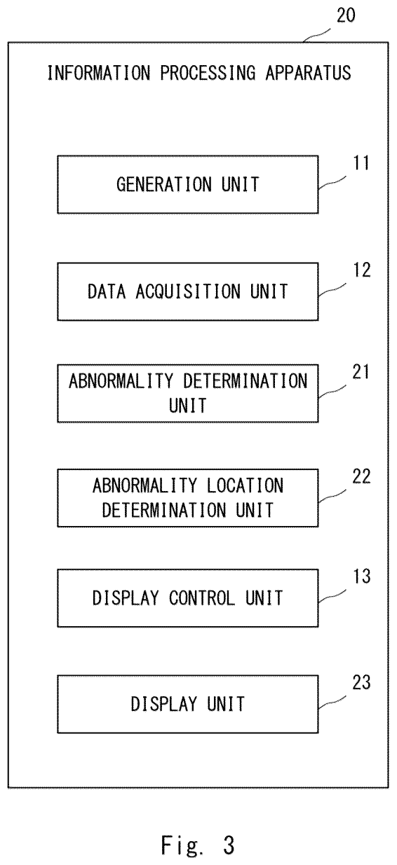

Next, a configuration example of an information processing apparatus 20 will be described with reference to FIG. 3. The information processing apparatus 20 has a configuration in which an abnormality determination unit 21, an abnormality location determination unit 22, and a display unit 23 are added to the information processing apparatus 10 of FIG. 1. In the information processing apparatus 20, detailed descriptions of constituent elements similar to those of the information processing apparatus 10 will be omitted. The constituent elements of the information processing apparatus 20 may be software or modules in which processing is executed by a processor executing a program stored in a memory. Alternatively, the constituent elements of the information processing apparatus 20 may be hardware such as a circuit or a chip.

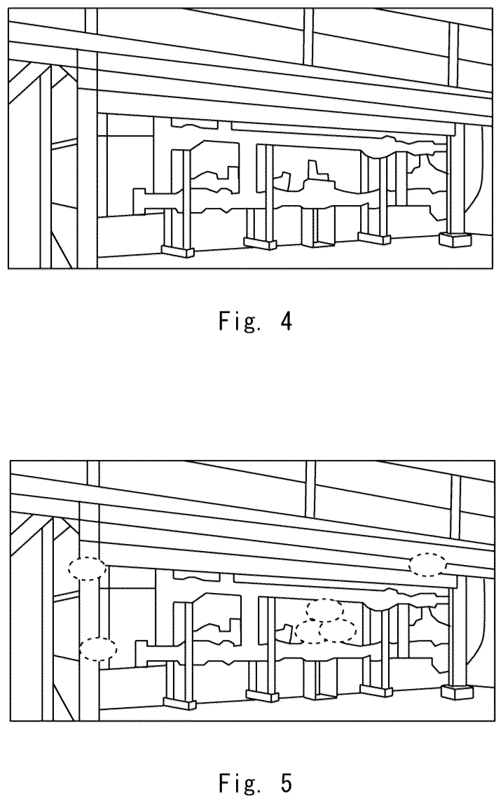

A generation unit 11 generates point cloud data as three-dimensional data including a monitoring target facility. FIG. 4 illustrates one example of point cloud data. FIG. 4 illustrates equipment in a substation by using point cloud data. Although FIG. 4 is illustrated in a simplified manner in order to easily illustrate the shape of the equipment, in practice the shape of the equipment is illustrated as a set of points. Specifically, the points are distributed on a boundary line of the equipment and on the surface of the equipment. The boundary line of the equipment may be a line indicating a boundary between the equipment and the background or a boundary between the equipment and other equipment. The point cloud data are generated using, for example, a LiDAR apparatus. The LiDAR apparatus may be referred to as a laser scanner. A LiDAR apparatus may be used as the generation unit 11. Alternatively, the generation unit 11 may acquire point cloud data generated by the LiDAR apparatus from the LiDAR apparatus via a network or the like.

The LiDAR apparatus measures the distance to the object by using, for example, a time of flight (ToF) method, and generates a point indicating the shape of the object. A set of points indicating the shape of the object becomes point cloud data. The points indicating the shape of the object may be determined using three-dimensional coordinates in a predetermined space.

A data acquisition unit 12 acquires sensor data from each of a plurality of types of sensors. Further, the data acquisition unit 12 may acquire point cloud data including a monitoring target facility from the generation unit 11. The sensors may be located in the vicinity of the monitoring target facility or may be attached to the monitoring target facility.

For example, the LiDAR apparatus may be installed at a position where point cloud data of the monitoring target facility can be acquired. In other words, the LiDAR apparatus may be installed at a position where an image of the monitoring target facility can be captured. Thermography used as a temperature sensor may be installed at a position capable of measuring the temperature of the surface of the monitoring target facility. A vibration sensor may be attached to the surface of the monitoring target facility and detect the occurrence of vibration. A microphone may be installed at a position where sound emitted from the monitoring target facility can be collected. An odor sensor may be installed at a position where odor emitted by the monitoring target facility can be detected. Only one sensor may be installed, or a plurality of sensors may be installed.

The abnormality determination unit 21 determines whether an abnormality occurs in the monitoring target facility by using the sensor data acquired by the data acquisition unit 12. For example, the abnormality determination unit 21 may input the point cloud data generated by using the LiDAR apparatus to a trained model and receive a determination result of whether there is an abnormality. The trained model is assumed to have learned in advance via machine learning point cloud data of the monitoring target facility in a normal state or point cloud data of the monitoring target facility in a state in which an abnormality occurs. The trained model may receive the point cloud data as an input and output a determination result indicating whether an abnormality occurs in the shape indicated by the point cloud data. Further, when an abnormality occurs, the trained model may output data indicating a location where the abnormality occurs.

The abnormality determination unit 21 may determine that an abnormality occurs in a location having a temperature higher than a predetermined temperature. Alternatively, the abnormality determination unit 21 may determine that an abnormality occurs in a location having a temperature lower than a predetermined temperature. The abnormality determination unit 21 determines a distance and direction from a place where the temperature sensor is installed to the location where an abnormality occurs.

The abnormality determination unit 21 may determine that an abnormality occurs at a location where a vibration sensor is attached, when the vibration sensor attached to the surface of the monitoring target facility detects occurrence of vibration. Alternatively, the abnormality determination unit 21 may detect the occurrence of vibration from an image of a structure captured by using the camera, by using an optical vibration analysis technique that captures fine movement of the surface. The abnormality determination unit 21 may determine that an abnormality occurs at a location where vibration occurs. The abnormality determination unit 21 determines, for example, a distance and direction from a place where the camera is installed to the location where the abnormality occurs.

The abnormality determination unit 21 may determine a sound source by using the arrival time difference of sound waves collected by microphones installed at two or more locations around the monitoring target facility. Alternatively, the abnormality determination unit 21 may form an acoustic beam by taking the sum of sound waves detected by each of the microphones. The abnormality determination unit 21 may determine the sound source by using the preference pattern of the acoustic beam. The abnormality determination unit 21 may determine that an abnormality occurs at the location of the determined sound source when a sound volume equal to or higher than a predetermined level or equal to or higher than a predetermined decibel (dB) is detected. The abnormality determination unit 21 determines a distance and direction from a position determined based on the position of the microphone, such as a place where one of the microphones is installed or a center position of a figure having a plurality of microphones as vertices, to the location where the abnormality occurs.

The abnormality determination unit 21 may determine in advance a position where an odor is generated when an abnormality occurs in the monitoring target facility. For example, a monitoring person may input, to the abnormality determination unit 21, information related to a position at which an odor occurs when an abnormality occurs. The information related to the position at which the odor occurs when the abnormality occurs may be, for example, a position in the point cloud data of FIG. 4. When the value of the odor indicated by the sensor data exceeds a predetermined value, the abnormality determination unit 21 may determine that an abnormality occurs at the position determined in advance as a position where the odor occurs when the abnormality occurs.

The abnormality location determination unit 22 generates abnormality location data indicating a location where an abnormality occurs in the monitoring target facility. Specifically, the abnormality location determination unit 22 specifies at which position in the point cloud data illustrated in FIG. 4 the abnormality occurs. More specifically, the abnormality location determination unit 22 determines which position in the point cloud data illustrated in FIG. 4 corresponds to the position where the abnormality is determined to occurs by the abnormality determination unit 21.

The abnormality location determination unit 22 determines in advance the distance between the LiDAR apparatus used for generating the point cloud data illustrated in FIG. 4 and each of the sensors. Furthermore, the abnormality location determination unit 22 determines in advance the direction or orientation in which each sensor is installed with reference to the LiDAR apparatus. That is, the abnormality location determination unit 22 specifies in advance a position where each sensor is installed with reference to the LiDAR apparatus. The position with reference to the LiDAR apparatus may be a position on coordinates determined with the position of the LiDAR apparatus as an origin.

For example, the abnormality location determination unit 22 determines a position in the point cloud data, which is based on the position of the LiDAR apparatus, that is relevant to the distance and direction to the location where the abnormality occurs, determined by the abnormality determination unit 21. In other words, the abnormality location determination unit 22 applies the distance and direction to the location where the abnormality occurs, which are determined by the abnormality determination unit 21, with the position of the LiDAR apparatus as the starting point. The abnormality location determination unit 22 determines, with the position of the LiDAR apparatus as a starting point, a position in the point cloud data relevant to a position indicated by the distance and direction to the location where the abnormality occurs.

Further, the abnormality location determination unit 22 corrects the determined position in the point cloud data in accordance with the positional relationship between the LiDAR apparatus and each sensor. For example, in a case where the position of the sensor is separated from the LiDAR apparatus by a distance A (A is a positive number, the unit thereof being meter, centimeter, millimeter, or the like) to the right, the abnormality location determination unit 22 determines a position away from the determined position in the point cloud data by the distance A to the right as the location where the abnormality occurs.

The abnormality location determination unit 22 does not need to correct the abnormality location detected based on the shape of the point cloud data generated by using the LiDAR apparatus. Further, the abnormality location determination unit 22 does not need to correct the position determined as the position where the abnormality is generated by using the odor sensor.

FIG. 5 illustrates the position determined as the abnormality location by the abnormality location determination unit 22 by using a dotted line having a curved shape. FIG. 5 illustrates the point cloud data generated by the generation unit 11 on which the position determined as the abnormality location by the abnormality location determination unit 22 is superimposed. The position determined as the abnormality location may be indicated using a dotted line of a curved shape as illustrated in FIG. 5, indicated using a solid line, or indicated using a shape other than a curved shape. Further, the position determined as the abnormality location may be indicated by using different shapes, different colors, different patterns, different line types, and the like for each piece of sensor data used for determining the occurrence of abnormality.

Referring back to FIG. 3, a display control unit 13 generates display data to be displayed on the display unit 23. The display unit 23 may be, for example, a display apparatus such as a display. The display data are data in which abnormality data indicating an abnormal state that occurs in the monitoring target facility are associated with the point cloud data. The abnormality data include abnormality location data indicating an abnormality occurrence location and additional data related to the abnormality that occurs in the monitoring target facility.

The additional data may be, for example, data indicating the cause of the abnormality that occurs in the monitoring target facility. Further, the additional data may be data in which the abnormality location is displayed in a highlighted manner. Further, the additional data may include both data indicating the cause of the abnormality that occurs in the monitoring target facility and data in which the abnormality location is displayed in a highlighted manner.

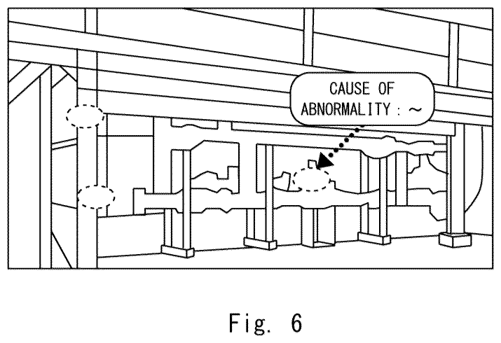

The display control unit 13 may generate display data to be displayed on the display unit 23, based on the data determined by the abnormality location determination unit 22 and illustrated in FIG. 5. For example, in a case where two or more pieces of abnormality location data exist within a predetermined range or in a case where ranges indicated by two or more pieces of abnormality location data overlap each other, the display control unit 13 may highlight and display the abnormality location, such as causing the two or more pieces of abnormality location data to flash. In the case where two or more pieces of abnormality location data exist within a predetermined range or the like, the severity of the abnormality may be regarded as being large. An example of highlighting and displaying may include, in addition to the flashing display, using a color different from other pieces of abnormality location data, using a specific pattern, surrounding the ranges indicated by the two or more pieces of abnormality location data by a dotted line or a solid line, and the like. Further, as illustrated in FIG. 6, the display control unit 13 may display the cause of the abnormality in the abnormality location.

Further, there are cases where the abnormality determination unit 21 determines that there is an abnormality location from the image data captured by the camera but determines, from the sensor data, that there is no abnormality location in the point cloud data related to the same location where the camera captures the image. In such a case, the display control unit 13 may prioritize the determination made using the point cloud data and determine that there is no abnormality location. Further, the display control unit 13 may set in advance a priority order between the determination result using the point cloud data and the determination result using each piece of the sensor data, and perform abnormality determination based on the priority order. The abnormality determination based on the priority order may be performed by preferentially adopting a determination result based on sensor data having higher priority.

The display control unit 13 may generate additional data, based on the information related to the monitoring target facility and the determination result of the abnormality determination unit 21. For example, it is assumed that the display control unit 13 holds, as the information related to the monitoring target facility, information indicating that gas or oil is contained in the monitoring target facility or that gas or oil is flowing inside the monitoring target facility. In such a state, when the abnormality determination unit 21 detects an abnormality, based on the sensor data generated by the LiDAR apparatus and the sensor data generated by the odor sensor, the display control unit 13 determines that the cause of the abnormality is gas leakage or oil leakage. The display control unit 13 generates additional data indicating that the cause of the abnormality is gas leakage or oil leakage.

Further, it is assumed that the display control unit 13 holds, as the information related to the monitoring target facility, information indicating that the monitoring target facility is in the vicinity of the sea. Being in the vicinity of the sea may mean that the distance from the monitoring target facility to the sea is closer than a predetermined distance. In such a state, when the abnormality determination unit 21 detects an abnormality, based on the sensor data generated by the LiDAR apparatus, the display control unit 13 determines that the cause of the abnormality is salt damage, and generates additional data indicating that the cause of the abnormality is salt damage.

The display control unit 13 is not limited to these examples, and may determine in advance the cause of the abnormality in a case where the information related to the monitoring target facility and the determination result in the abnormality determination unit 21 are combined. Further, the display control unit 13 may determine in advance the cause of the abnormality that is assumed when two or more pieces of abnormality location data exist within a predetermined range.

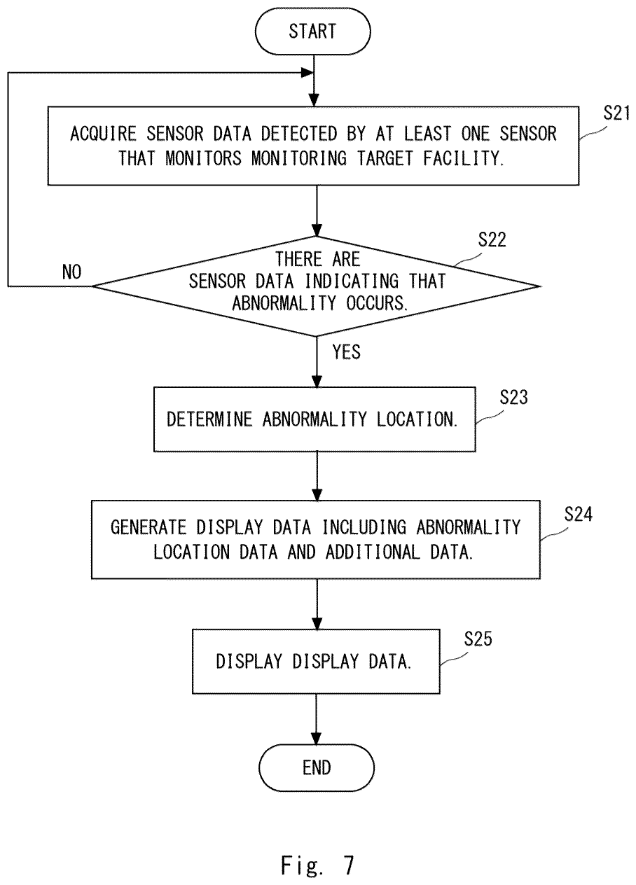

Next, a data display method for the information processing apparatus 20 will be described with reference to FIG. 7. In FIG. 7, it is assumed that the generation unit 11 generates in advance point cloud data including the monitoring target facility. Alternatively, it is assumed that the generation unit 11 acquires or holds in advance point cloud data including the monitoring target facility.

First, the data acquisition unit 12 acquires sensor data detected by at least one sensor that monitors the monitoring target facility (S21). The data acquisition unit 12 may acquire sensor data at different timings for each sensor, or may acquire sensor data from all sensors at the same timing. Further, the data acquisition unit 12 may set the timing of acquiring sensor data from several sensors among all the sensors to the same timing. Further, each of the sensors may output or transmit the sensor data to the data acquisition unit 12 at a timing when a change in a state is detected. Detecting a change in a state may be detecting sound, smell, vibration, or the like. Further, detecting a change in a state may be detecting sensor data indicating a value exceeding a predetermined value. Further, detecting a change in a state may be that a difference between a value indicated by the most recent sensor data and a value indicated by the sensor data generated so far is larger than a threshold value.

Next, the abnormality determination unit 21 determines whether sensor data indicating that an abnormality occurs is present in the acquired sensor data (S22). When the abnormality determination unit 21 determines that there is no sensor data indicating that an abnormality occurs, the process of step S21 is repeated.

When determining that sensor data indicating that an abnormality occurs are present, the abnormality determination unit 21 determines an abnormality location (S23). The sensor data indicating that an abnormality occurs may be, for example, sensor data which make it possible to determine whether an abnormality occurs visually, tactilely, aurally, or olfactorily. When sensor data indicating that an abnormality occurs due to at least one of visual, tactile, auditory, and olfactory sensation are included, the abnormality determination unit 21 may determine that sensor data indicating that an abnormality occurs are present. Further, as illustrated in FIG. 5, the abnormality determination unit 21 determines an abnormality location within the point cloud data.

Next, the display control unit 13 generates display data including the abnormality location data and the additional data (S24). The display control unit 13 may display the abnormality location data and the additional data on the point cloud data, which include the monitoring target facility, in a superimposed manner. The position of the additional data to be superimposed on the point cloud data may be, for example, a position that does not overlap with the abnormality location data, or may be a predetermined position.

Next, the display control unit 13 displays the display data on the display unit 23 (S25). The user who operates the information processing apparatus 20 can visually recognize the display data displayed on the display unit 23.

As described above, the information processing apparatus 20 generates the abnormality data including the abnormality location data and the additional data by combining the plurality of types of sensor data or by combining the at least one piece of sensor data and the information related to the monitoring target facility. Further, the information processing apparatus 20 displays abnormality data. As a result, the user of the information processing apparatus 20 can confirm additional data that cannot be acquired from a single type of sensor data. As a result, the user of the information processing apparatus 20 can efficiently perform the monitoring work of the monitoring target facility.

FIG. 3 illustrates a configuration in which the information processing apparatus 20 includes the generation unit 11, the data acquisition unit 12, the abnormality determination unit 21, the abnormality location determination unit 22, the display control unit 13, and the display unit 23, but the information processing apparatus is not limited to such a configuration.

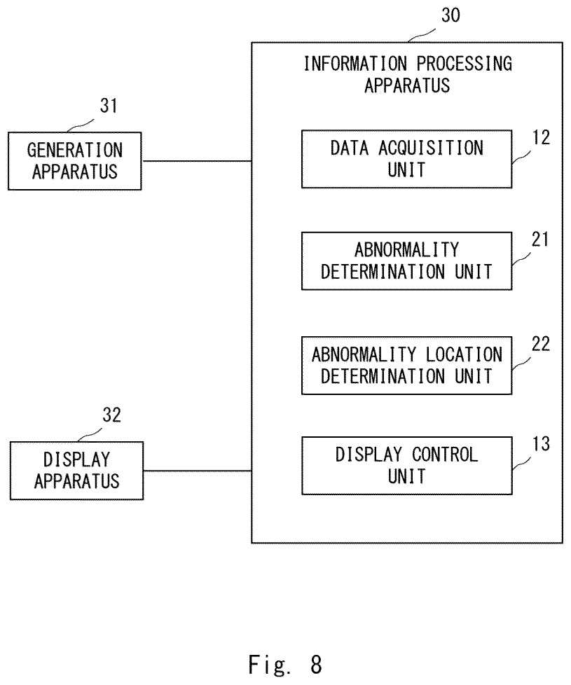

For example, the information processing apparatus may include a data acquisition unit 12, an abnormality determination unit 21, an abnormality location determination unit 22, and a display control unit 13 as in an information processing apparatus 30 illustrated in FIG. 8. Further, the generation unit 11 may be used as a generation apparatus 31 being an apparatus different from the information processing apparatus 30. Further, the display unit 23 may be used as a display apparatus 32 being an apparatus different from the information processing apparatus 30. The generation apparatus 31 and the display apparatus 32 may be a computer apparatus that operates when a processor executes a program stored in a memory. The generation apparatus 31 and the display apparatus 32 may be connected to the information processing apparatus 30 via a network, or may be connected to the information processing apparatus 30 via a cable or the like. Alternatively, the generation apparatus 31 and the display apparatus 32 may be connected to the information processing apparatus 30 via a wireless communication line.

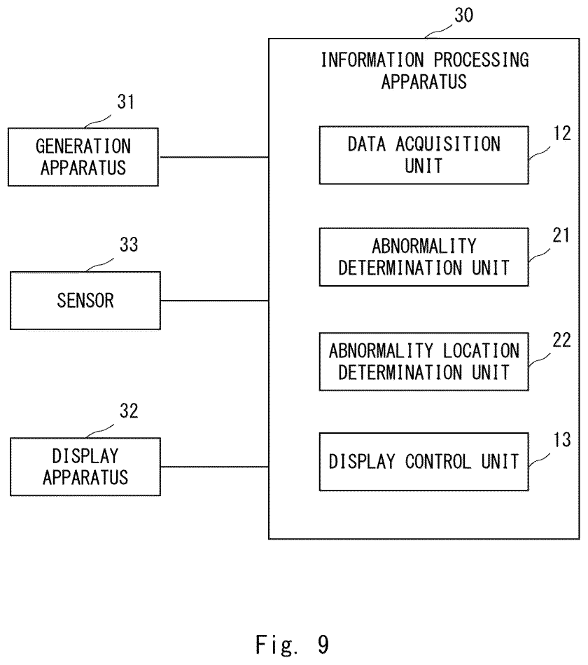

Further, as illustrated in FIG. 9, the information processing apparatus 30 may constitute a monitoring system together with the generation apparatus 31, the display apparatus 32, and a sensor 33 that monitors the monitoring target facility. The monitoring system may include the information processing apparatus 20 and the sensor 33. Each of the apparatuses and sensors constituting the monitoring system may be connected via a network.

### Third Example Embodiment

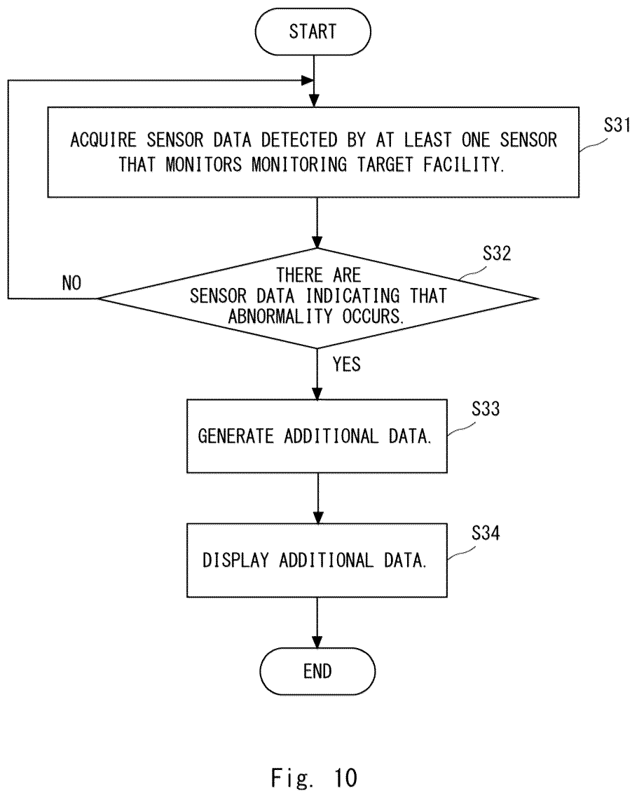

Next, a flow of additional data generation processing in the information processing apparatus 20 will be described with reference to FIG. 10. Steps S31 and S32 in FIG. 10 are the same as steps S21 and S22 in FIG. 7, and thus detailed description thereof will be omitted.

Next, the display control unit 13 generates additional data without performing the determination of an abnormality location by the abnormality location determination unit 22 illustrated in FIG. 7 (S33). For example, when there are sensor data indicating that an abnormality occurs, the abnormality location determination unit 22 may determine that an abnormality occurs at any location in the monitoring target facility. In other words, when there are sensor data indicating that an abnormality occurs, the abnormality location determination unit 22 may determine that an abnormality occurs in the monitoring target facility without determining a detailed abnormality location.

The display control unit 13 may generate data indicating a cause of an abnormality that occurs in the monitoring target facility by using a plurality of types of sensor data, or at least one piece of sensor data and information related to the monitoring target facility, as additional data. Then, the display control unit 13 displays the additional data on the display unit 23 (S34).

As described above, in the additional data generation processing in FIG. 10, the display control unit 13 generates the additional data without determining the detailed abnormality location in the monitoring target facility. As a result, for example, for a facility or the like having a simple structure that does not need to determine a detailed abnormality location, additional data are generated through processing with a smaller load than in the case where processing for specifying a detailed abnormality location is performed.

### Fourth Example Embodiment

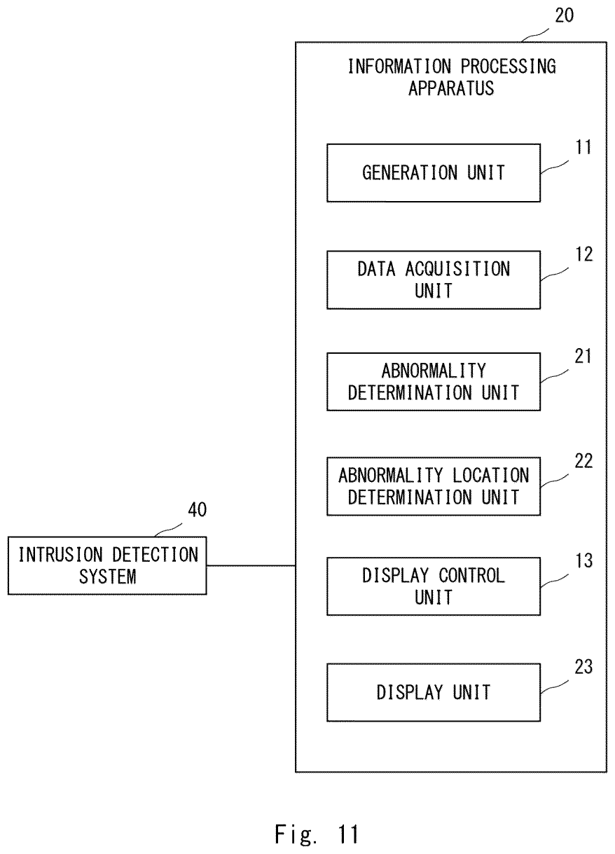

Next, abnormality data generation processing using an intrusion detection system 40 will be described with reference to FIG. 11. FIG. 11 illustrates a monitoring system including the intrusion detection system 40. In the monitoring system, the information processing apparatus 30 may be used instead of the information processing apparatus 20. Further, the monitoring system may include the sensor 33.

The intrusion detection system 40 may be, for example, a system that provides a service used by a manager or the like of the monitoring target facility in order to monitor the monitoring target facility. The intrusion detection system 40 provides, for example, a service for detecting a person who intrudes into the monitoring target facility. The intrusion of a person into the monitoring target facility may be an intrusion of a person into a predetermined area including the monitoring target facility. The intrusion detection system may detect a person by using, for example, a temperature sensor, an infrared sensor, a camera, or the like.

The information processing apparatus 20 may be connected to the intrusion detection system 40 via a network. Upon receiving a message notifying the intrusion of a person from the intrusion detection system 40, the information processing apparatus 20 may display, on the display unit 23, a warning message or the like indicating the intrusion of a person.

Herein, it is assumed that the intrusion detection system 40 can detect a human, but cannot detect an animal or an organism other than a human. For example, when the intrusion detection system 40 detects a human intrusion by detecting a human characteristic such as a human body temperature, it is not possible to detect an animal or an organism other than a human.

The display control unit 13 may determine that an animal or organism other than a human has intruded into the monitoring target facility when it is determined that an abnormality occurs visually by using a camera or the like, although information indicating that a human is detected is not notified from the intrusion detection system 40. Alternatively, the display control unit 13 may determine that an animal or organism other than a human has intruded into the monitoring target facility when it is determined that an abnormality occurs aurally by using a microphone or the like, although information indicating that a human is detected is not notified from the intrusion detection system 40. Further, the display control unit 13 may determine that an animal or organism other than a human has intruded into the monitoring target facility when it is determined that an abnormality occurs olfactorily by using an odor sensor or the like, although information indicating that a human is detected is not notified from the intrusion detection system 40.

In such a way, the information processing apparatus 20 can detect the intrusion of an animal or an organism other than a human by using the information notified from the intrusion detection system capable of detecting the intrusion of a human. Although the operation of the information processing apparatus 20 in cooperation with the intrusion detection system has been described in FIG. 11, the system in cooperation with the information processing apparatus 20 is not limited to the intrusion detection system. The information processing apparatus 20 may generate useful information to be displayed on the display unit 23 by using information notified from a system that provides another service for monitoring the monitoring target facility, another service used by a company or the like having the monitoring target facility, or the like.

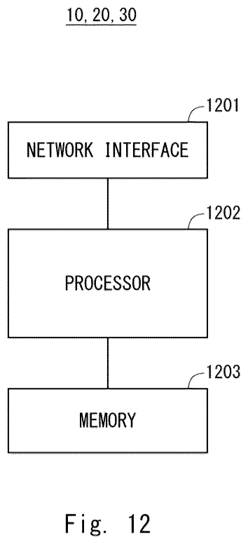

FIG. 12 is a block diagram illustrating a configuration example of the information processing apparatuses 10, 20, and 30 (hereinafter, referred to as the information processing apparatus 10 and the like). Referring to FIG. 12, the information processing apparatus 10 and the like include a network interface 1201, a processor 1202, and a memory 1203. The network interface 1201 may be used to communicate with network nodes. The network interface 1201 may include, for example, a network interface card (NIC) compliant with IEEE 802.3 series. IEEE represents Institute of Electrical and Electronics Engineers.

The processor 1202 reads and executes software (computer program) from the memory 1203, thereby performs processing of the information processing apparatus 10 and the like described with reference to the flowcharts in the above-described example embodiments. The processor 1202 may be, for example, a microprocessor, an MPU, or a CPU. The processor 1202 may include a plurality of processors.

The memory 1203 includes a combination of a volatile memory and a non-volatile memory. The memory 1203 may include storage located remotely from the processor 1202. In such a case, the processor 1202 may access the memory 1203 via an input/output (I/O) interface (not illustrated).

In the example of FIG. 12, the memory 1203 is used to store software modules. The processor 1202 reads and executes these software modules from the memory 1203 and thereby performs processing of the information processing apparatus 10 and the like described in the above-described example embodiments.

As described with reference to FIG. 12, each of the processors included in the information processing apparatus 10 or the like executes one or a plurality of programs including instructions for causing a computer to execute the algorithm described with reference to the drawings.

In the examples described above, the program includes instructions (or software code) that, when loaded into a computer, cause the computer to perform one or more of the functions described in the example embodiments. The program may be stored in a non-transitory computer-readable medium or a tangible storage medium. By way of example, and not limitation, the computer-readable medium or tangible storage medium includes a random-access memory (RAM), read-only memory (ROM), flash memory, solid-state drive (SSD) or other memory techniques, a CD-ROM, digital versatile disc (DVD), Blu-ray disk (registered trademark) or other optical disk storages, or a magnetic cassette, magnetic tape, magnetic disk storage or other magnetic storage devices. The program may be transmitted on a transitory computer-readable medium or a communication medium. By way of example, and not limitation, the transitory computer-readable medium or communication medium includes electrical, optical, acoustic, or other forms of propagated signals.

While the present disclosure has been particularly shown and described with reference to example embodiments thereof, the present disclosure is not limited to these example embodiments. It will be understood by those of ordinary skill in the art that various changes in form and details may be made therein without departing from the spirit and scope of the present disclosure as defined by the claims. And each example embodiment can be appropriately combined with at least one of example embodiments.

Each of the drawings or figures is merely an example to illustrate one or more example embodiments. Each figure may not be associated with only one particular example embodiment, but may be associated with one or more other example embodiments. As those of ordinary skill in the art will understand, various features or steps described with reference to any one of the figures can be combined with features or steps illustrated in one or more other figures, for example, to produce example embodiments that are not explicitly illustrated or described. Not all of the features or steps illustrated in any one of the figures to describe an example embodiment are necessarily essential, and some features or steps may be omitted. The order of the steps described in any of the figures may be changed as appropriate.

The whole or part of the example embodiments disclosed above can be described as, but not limited to, the following supplementary notes.

### (Supplementary Note 1)

An information processing apparatus comprising:
a generation unit configured to generate three-dimensional data including a monitoring target facility;
a data acquisition unit configured to acquire sensor data detected by at least one sensor configured to monitor the monitoring target facility; and
a display control unit configured to generate display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

### (Supplementary Note 2)

The information processing apparatus according to supplementary note 1, wherein the abnormality data include abnormality location data indicating a location of an abnormality that occurs in the monitoring target facility and additional data related to the abnormality that occurs in the monitoring target facility.

### (Supplementary Note 3)

The information processing apparatus according to supplementary note 2, wherein the additional data indicate a cause of the abnormality that occurs in the monitoring target facility.

### (Supplementary Note 4)

The information processing apparatus according to supplementary note 2, wherein the additional data include the abnormality location displayed in a highlighted manner.

### (Supplementary Note 5)

The information processing apparatus according to any one of supplementary notes 1 to 4, wherein the information related to the monitoring target facility indicates an installation position of the monitoring target facility.

### (Supplementary Note 6)

The information processing apparatus according to any one of supplementary notes 1 to 4, wherein the information related to the monitoring target facility is information related to an intrusion detection service to be used by the monitoring target facility.

### (Supplementary Note 7)

The information processing apparatus according to any one of supplementary notes 1 to 4, further comprising a determination unit configured to determine an abnormality location of the monitoring target facility included in the three-dimensional data, based on a distance between a measurement apparatus configured to generate the three-dimensional data and at least one of the sensors.

### (Supplementary Note 8)

The information processing apparatus according to any one of supplementary notes 1 to 7, further comprising a display unit configured to display the display data.

### (Supplementary Note 9)

A monitoring system comprising:
at least one sensor configured to monitor a monitoring target facility;
a generation apparatus configured to generate three-dimensional data including the monitoring target facility;
an information processing apparatus including a data acquisition unit configured to acquire sensor data detected by at least one of the sensors, and a display control unit configured to generate display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility; and
a display apparatus configured to display the display data.

### (Supplementary Note 10)

A data generation method comprising:
generating three-dimensional data including a monitoring target facility;
acquiring sensor data detected by at least one sensor configured to monitor the monitoring target facility; and
generating display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

### (Supplementary Note 11)

A non-transitory computer-readable medium storing a program that causes a computer to execute:
generating three-dimensional data including a monitoring target facility;
acquiring sensor data detected by at least one sensor configured to monitor the monitoring target facility; and
generating display data of displaying, on the three-dimensional data, abnormality data indicating an abnormal state that occurs in the monitoring target facility, the abnormality data being acquired by combining a plurality of types of the sensor data or combining at least one piece of the sensor data and information related to the monitoring target facility.

Some or all of elements (e.g., structures and functions) specified in Supplementary Notes 2 to 8 dependent on Supplementary Note 1 may also be dependent on Supplementary Note 9 to Supplementary Note 11 in dependency similar to that of Supplementary Notes 2 to 8 on Supplementary Note 1. Some or all of elements specified in any of Supplementary Notes may be applied to various types of hardware, software, and recording means for recording software, systems, and methods.

According to the present disclosure, it is possible to provide an information processing apparatus, a monitoring system, a data generation method, and a program that make it possible to display information useful for performing monitoring work.

What is claimed is:

1. An information processing apparatus comprising:
at least one memory storing instructions; and
at least one processor configured to execute the instructions to:
generate three-dimensional data including a monitoring target facility;
acquire sensor data detected by at least one sensor configured to monitor the monitoring target facility; and
generate display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

2. The information processing apparatus according to claim 1, wherein the abnormality data include abnormality location data indicating a location of an abnormality that occurs in the monitoring target facility and additional data related to the abnormality that occurs in the monitoring target facility.

3. The information processing apparatus according to claim 2, wherein the additional data indicate a cause of the abnormality that occurs in the monitoring target facility.

4. The information processing apparatus according to claim 2, wherein the additional data include the abnormality location displayed in a highlighted manner.

5. The information processing apparatus according to claim 1, wherein the information related to the monitoring target facility indicates an installation position of the monitoring target facility.

6. The information processing apparatus according to claim 1, wherein the information related to the monitoring target facility is information related to an intrusion detection service to be used by the monitoring target facility.

7. The information processing apparatus according to claim 1, wherein the at least one processor is further configured to execute the instructions to determine an abnormality location of the monitoring target facility included in the three-dimensional data, based on a distance between a measurement apparatus configured to generate the three-dimensional data and at least one of the sensors.

8. The information processing apparatus according to claim 1, wherein the at least one processor is further configured to execute the instructions to display the display data.

9. A data generation method comprising:
generating three-dimensional data including a monitoring target facility;
acquiring sensor data detected by at least one sensor configured to monitor the monitoring target facility; and
generating display data of displaying, on the three-dimensional data, abnormality data indicating an abnormal state that occurs in the monitoring target facility, the abnormality data being acquired by combining a plurality of types of the sensor data or by combining at least one piece of the sensor data and information related to the monitoring target facility.

10. A non-transitory computer-readable medium storing a program that causes a computer to execute:
generating three-dimensional data including a monitoring target facility;
acquiring sensor data detected by at least one sensor configured to monitor the monitoring target facility; and
generating display data of displaying, on the three-dimensional data, abnormality data indicating an abnormal state that occurs in the monitoring target facility, the abnormality data being acquired by combining a plurality of types of the sensor data or combining at least one piece of the sensor data and information related to the monitoring target facility.
